(19) United States
(12) Patent Application Publication
(10) Pub. No.: US 2018/0101773 A1
(43) Pub. Date: Apr. 12, 2018

(54) APPARATUS AND METHOD FOR SPATIAL PROCESSING OF CONCEPTS

(71) Applicant: Futurewei Technologies, Inc., Plano, TX (US)

(72) Inventor: Jiangsheng Yu, San Jose, CA (US)

(21) Appl. No.: 15/289,052

(22) Filed: Oct. 7, 2016

(51) Int. Cl. G06N 5/04; G06F 17/16; G06F 17/30

(52) U.S. Cl. CPC G06N 5/04; G06F 17/30598; G06F 17/3053; G06F 17/16

(57) ABSTRACT

An apparatus and method are provided for spatial processing of concepts. Included is a non-transitory memory comprising a distance matrix and instructions, where the distance matrix includes values representing dissimilarities among a plurality of concepts stored in a knowledgebase. Further included is one or more processors in communication with the memory. The one or more processors execute the instructions to derive an inner product matrix, based on the distance matrix. Further, a spectral decomposition of the inner product matrix is performed. Based on the spectral decomposition of the inner product matrix, a plurality of concept vectors are generated. Information associated with the plurality of concept vectors is then output for spatial processing.

### FIELD OF THE INVENTION

The present invention relates to knowledgebases, and more particularly to processing information from a knowledgebase.

### BACKGROUND

Lexical databases such as WORDNET include a vast set of words that are grouped into sets of cognitive synonyms. To date, there have been very limited attempts to extract the contents of such lexical databases and present them in a spatial domain. Further, to the extent that such exercise has been attempted, such attempts have been limited to the analysis of words and the use of deep learning algorithms. Unfortunately, the use of deep learning algorithms in this regard is exceedingly slow and therefore costly in terms of the amount of resources required over time.

### SUMMARY

An apparatus, method, and non-transitory computer-readable media are provided for spatial processing of concepts.

A processing device is provided including a non-transitory memory comprising a distance matrix and instructions, with the distance matrix including values representing dissimilarities among a plurality of concepts stored in a knowledgebase, and one or more processors in communication with the memory. The one or more processors execute the instructions to derive an inner product matrix based on the distance matrix, perform a spectral decomposition of the inner product matrix, generate a plurality of concept vectors based on the spectral decomposition of the inner product matrix, and output information associated with the plurality of concept vectors for spatial processing.

A method is provided including a processing device deriving an inner product matrix based on a distance matrix, with the distance matrix including values representing dissimilarities among a plurality of concepts stored in a knowledgebase, the processing device performing a spectral decomposition of the inner product matrix, the processing device generating a plurality of concept vectors based on the spectral decomposition of the inner product matrix, and the processing device outputting information associated with the plurality of concept vectors for spatial processing.

A non-transitory computer-readable media storing computer instructions is provided, that when executed by one or more processors, cause the one or more processors to perform the steps of deriving an inner product matrix based on a distance matrix, with the distance matrix including values representing dissimilarities among a plurality of concepts stored in a knowledgebase, performing a spectral decomposition of the inner product matrix, generating a plurality of concept vectors based on the spectral decomposition of the inner product matrix, and outputting information associated with the plurality of concept vectors for spatial processing.

In some processing device, method, or computer-readable media embodiments, the spectral decomposition of the inner product matrix is configured such that the plurality of concept vectors are generated with a dimension that is equal to a rank of the inner product matrix.

In some processing device, method, or computer-readable media embodiments, the spectral decomposition of the inner product matrix is configured such that the plurality of concept vectors are generated with a dimension that is less than a rank of the inner product matrix.

In some processing device, method, or computer-readable media embodiments, receive user input including a dimension, wherein the plurality of concept vectors are generated with the dimension based on the spectral decomposition of the inner product matrix.

In some processing device, method, or computer-readable media embodiments, the spatial processing includes displaying the information associated with the plurality of concept vectors.

In some processing device, method, or computer-readable media embodiments, the spatial processing includes displaying the information associated with the plurality of concept vectors in Euclidean space.

In some processing device, method, or computer-readable media embodiments, a concept of the plurality of concepts includes at least one word, a phrase, or a plurality of words of a sentence.

In some processing device, method, or computer-readable media embodiments, assemble the plurality of concept vectors into a concept matrix representative of the sentence.

In some processing device, method, or computer-readable media embodiments, the spatial processing includes at least one of deep learning, text analysis, or clustering.

In some processing device, method, or computer-readable media embodiments, the information associated with the plurality of concept vectors includes one or both of the plurality of concept vectors or information derived from the plurality of concept vectors.

One or more of the foregoing features of the aforementioned apparatus, computer program product, and/or method may enable extraction of vectors related to concepts for use in spatial processing (e.g. displaying in Euclidian space) without necessarily relying on deep learning algorithms. This may, in turn, result in the production of such concept vectors (that are equipped for spatial processing) in a faster, more cost-effective manner that would otherwise be foregone in systems that lack such capabilities. It should be noted that the aforementioned potential advantages are set forth for illustrative purposes only and should not be construed as limiting in any manner.

### BRIEF DESCRIPTION OF THE DRAWINGS

FIG. 1 is a flow chart of a method for spatial processing of concepts, in accordance with an embodiment.

FIG. 2 illustrates an exemplary knowledgebase including a plurality of concepts (e.g. with associated words, etc.) and relationships therebetween, in accordance with an embodiment.

FIG. 3 illustrates an exemplary distance matrix including a plurality of concepts and relative distance values, in accordance with an embodiment.

FIG. 4 illustrates an exemplary inner product matrix including a plurality of concepts and inner products values, in accordance with an embodiment.

FIG. 5 is a plot resulting from spatial processing of concepts, in accordance with an embodiment.

FIG. 6 illustrates a network architecture, in accordance with an embodiment.

FIG. 7 illustrates an exemplary processing device, in accordance with an embodiment.

### DETAILED DESCRIPTION

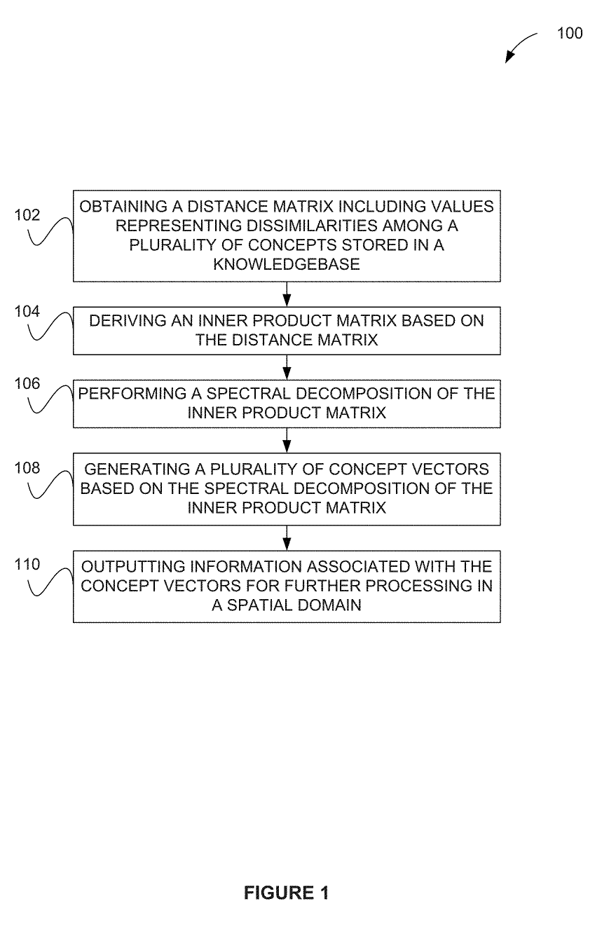

FIG. 1 is a flow chart of a method 100 for spatial processing of concepts, in accordance with an embodiment. In the context of the present description, a concept may relate to any person, place, or thing. Information related to such concepts may be stored in objects (e.g. data structures, etc.), where such information describes at least one aspect of the concept (e.g. using one or more words and/or any other representations, for that matter). Further, information about a relationship between the concept and one or more other concepts may be stored in such objects. Such relationship may take any form including, but not limited to, a distance indicator in the form of a shortest path or derivation thereof (e.g. shortest path plus one, shortest path multiplied by two, etc.), and/or any other indication of length, for that matter.

Prior to execution of the method 100, the foregoing objects may be stored in a knowledgebase that may take the form of a database capable of storing the foregoing objects. One exemplary knowledgebase is WORDNET that includes a vast set of words that are grouped into sets of cognitive synonyms. Cognitive synonyms can be defined as words with exact interchangeability, or can be defined as synonyms that are so similar in meaning that they cannot be differentiated either denotatively or connotatively. In one example definition, if a word is cognitively synonymous with another word, then the two words refer to the same thing independently of context. In another example definition, a word is cognitively synonymous with another word if and only if all instances of both words express the same exact thing, and the referents are necessarily identical, which means that the words' interchangeability is not context-sensitive. Of course, other knowledgebase are contemplated that store other concepts in other ways.

In natural language processing (NLP) and cognitive computing, a concept can be represented in Euclidean space as a vector. In machine learning and pattern recognition, an object (or concept) can be represented by a vector. A vector has a magnitude and a direction or orientation.

Where a knowledgebase describes/defines concepts by nodes and describes node relationships by edges, then dissimilarities between concepts can be measured and/or quantified by the distances between the nodes representing the concepts. Such concept vectors can be constructed to include such dissimilarity information in the knowledgebase, wherein a spatial distribution of the concept vectors provides a geometric representation/understanding of the concepts. Patterns are created in Euclidean space, with a pattern being based on a distance matrix extracted from a knowledgebase,

As a result of the execution of the method 100, concepts may be spatially processed. In the context of the present description, spatial processing refers to any processing that results in a representation of the concepts in space. For example, in one possible embodiment, the concepts may be spatially processed, for the purpose of displaying the concepts in 2- or 3-dimensional Euclidean space, and can be represented by one or more axes (e.g. x-axis, y-axis, z-axis). By this design, a user may, in one optional embodiment, readily visualize the foregoing concepts and any relationship among them. This may thus result in greater insight into the foregoing concepts and relationships.

With reference now to FIG. 1, in step 102, a distance matrix is shown to be obtained that includes values representing dissimilarities among a plurality of concepts stored in the aforementioned knowledgebase. It should be understood that the distance matrix can be formed and processed, can be received and processed, or can be obtained in any other manner. How the distance matrix is obtained is irrelevant. In the context of the present description, the distance matrix may refer to an array including relationships among multiple concepts, where a relationship is represented via specific values (e.g. real numbers, expressions, etc.). Further, in one embodiment, the aforementioned relationship values may relate to a distance (e.g. shortest path value or derivation thereof, etc.) among the concepts (where the values each may or may not be a metric). Through the inclusion of such relationship values among the concepts, the distance matrix thus indicates any dissimilarities (e.g. represented by the distance values dᵢⱼ) among the concepts.

For example, in one specific optional embodiment, a particular distance matrix A may be defined as set forth in Equation 1.

Δ_{n×n}=((dᵢⱼ)_{n×n}=(∥xᵢ−xⱼ∥₂)_{n×n} (1)

Where n is a number of rows and columns of the vector, and xᵢ, xⱼ include vectors.

It should be noted that any mathematical variable, expression, etc. of a particular equation disclosed herein, that is included in a subsequent equation, will not be defined repeatedly, as consistency among definitions may be assumed in the present description.

Based on such distance matrix, an inner product matrix is derived in step 104. In the context of the present description, the inner product matrix may include any matrix that results from a product of multiple vectors of the distance matrix. For example, in one possible embodiment, a particular inner product matrix P may be represented by generalized Equation 2, where the inner product matrix P is of some vectors x₁, . . . , xₓ ∈ [symbol] ^{d} (i.e. where vectors x₁, . . . , xₙ are each an element of [symbol] ^{d}, where [symbol] ^{d} is a set d of real numbers [symbol] ).

P_{n×n}=(pᵢⱼ)_{n×n}=(xᵢ^{τ}xⱼ)_{n×n} (2)

Where τ denotes a transpose of a matrix.

In the present embodiment represented by Equations 1-2, Property 1 below illustrates a relationship between the distance matrix Δ and the inner product matrix P, and Equation 3 illustrates an exemplary, specific mechanism for the calculation of the inner product matrix P.

Property 1: Let x₁, . . . , xₙ ∈ R^{d} be centralized, that is, x₁+ . . . +xₙ=0. Then, the inner product matrix P=(pᵢⱼ)_{n×n} may be constructed by the distance matrix Δ=(dᵢⱼ)_{n×n} as follows.

$$P = - \frac{1}{2} H {Δ}^{2} H , where \{ \begin{matrix}{Δ}^{2} = {( {d}_{ij}^{2} )}_{n \times n} \\ H = {I}_{n} - \frac{1}{n} {n}_{}\end{matrix} \qquad ( 3 )$$

Where lₙ denotes the n×n identity matrix, [symbol] ₙ denotes the n×n matrix whose entities are all 1's, and H is defined above.

Per step 106, a spectral decomposition of the inner product matrix is performed. In the present description, spectral decomposition may refer to any process that results in a factorization of a matrix represented in terms of its eigenvalues and/or eigenvectors. Further, the aforementioned factorization, in one embodiment, may refer to any decomposition that results in a product of other factors, which, when multiplied together, result in the original. In one possible embodiment, the factorization may result in the matrix being represented in a canonical (e.g. normal, standard, etc.) form. Still yet, in one possible embodiment, the spectral decomposition may include an eigendecomposition.

Based on the spectral decomposition of the inner product matrix, a plurality of concept vectors are generated per step 108. In the present description, the concept vectors may refer to any vectors that each represent one or more of the aforementioned concepts and may be used for spatial processing, for the reasons indicated earlier. In various embodiments, the concept vectors may be of any dimension (e.g. 2-dimension, 3-dimension, etc.). More information will now be set forth regarding one possible way particular concept vectors y₁; . . . yₙ may be generated based on the spectral decomposition.

During generation of the concept vectors y₁; . . . yₙ ∈ [symbol] ^{k} (i.e. where concept vectors y₁; . . . yₙ are each an element of [symbol] ^{k}, where [symbol] ^{k} is a set k of real numbers [symbol] ) for some or all of the concepts in the knowledgebase, it may be desired to follow the conditions of ∥yᵢ−yⱼμ₂=dᵢⱼ,∀i,j ∈ {1, . . . , n}, as much as possible. In keeping with this desire, the following optimization problem, represented by Expression 1 below (which includes an objective function), is utilized to generate the concept vectors y₁; . . . , yₙ.

$$\begin{matrix}argmin \\ y 1 ; … , yn ∈ {ℝ}^{k}\end{matrix} {\sum }_{i < j} {( {‖ {y}_{i} - {y}_{j} ‖}_{2} - {d}_{ij} )}^{2}$$

The foregoing function strives to minimize a difference between the concept vectors y₁; . . . , yₙ (to be generated) and the associated distance vectors, in the manner indicated. By doing so, the resultant concept vectors y₁; . . . , yₙ most accurately reflect (or inherit) the relationships (e.g. distance) between the concepts. In a fully optimized example, the concept vectors will be selected such that the foregoing function will be zero (0). As will be described later, such accuracy may be balanced with efficiency, in various embodiments that trade-off such characteristics.

Given the semantic distance matrix Δ and Property 1 set forth earlier, one possible algorithm will now be described that returns a solution to Expression 1. Specifically, spectral decomposition is carried out on Equation 4 below.

P=VΛV^{τ}=V diag(λ₁, . . . , λ_{T})V^{τ} (4)

Where V is an orthogonal matrix, λ₁, . . . , λ_{T} are eigenvalues of P, and ∧ is a diagonal function, as indicated above.

Thus, by the spectral decomposition being carried out on Equation 4 above, a solution to Expression 1 in [symbol] ^{r}, where [symbol] ^{r} is a set r of real numbers [symbol] , is produced as follows in Equation 5.

$$Y = {Λ}^{\frac{1}{2}} {V}^{⊤} \qquad ( 5 )$$

Where

$${Λ}^{\frac{1}{2}} = diag ( \sqrt{{λ}_{1}} , ⋯ , \sqrt{{λ}_{r}} ,$$

As is evident, P=Y^{τ} Y, thus P is the inner product matrix of columns of Y_{r×n}, with Vₖ being a first k columns of V_{n×r} and Λₖ=diag(\sqrt{λ₁}, . . . , \sqrt{λₖ}, where k≤r, an approximation in [symbol] ^{k}, where [symbol] ^{k} is a set k of real numbers [symbol] , is set forth in Equation 6.

$${Y}_{k} = {Λ}_{k}^{\frac{1}{2}} {V}_{k}^{⊤} \qquad ( 6 )$$

Where Y is a matrix with each column being a concept vector.

To this end, an optimal approximation of P in all n×n matrices with rank k, is reflected as Pₖ=Yₖ^{τ}Yₖ. As mentioned earlier, the accuracy with which the concept vectors may represent relationships between concepts may be balanced with efficiency, as desired. For example, the spectral decomposition of the inner product matrix (see step 106) may be configured such that the concept vectors are generated with a dimension that is equal to a rank of the inner product matrix. This may thus generate concept vectors with optimal accuracy, at the possible expense of efficiency (in terms of computing resources, time, cost, etc.).

In another embodiment, the spectral decomposition of the inner product matrix may be configured such that the concept vectors are generated with a dimension that is less than a rank of the inner product matrix. This may thus generate concept vectors with less than optimal accuracy, so as to increase computing efficiency. In order to accomplish this in accordance with one embodiment, user input may be received that includes a particular dimension. Further, the concept vectors may be generated with the dimension, based on the spectral decomposition of the inner product matrix. By this design, the user may control the aforementioned tradeoff between concept vector accuracy and computing efficiency in generating the same.

With continuing reference to FIG. 1, information associated with the concept vectors is then outputted for spatial processing per step 110. In the present description, such information associated with the concept vectors may include one or more of the concept vectors themselves, and/or any information derived therefrom. Further, as mentioned earlier, the spatial processing may refer to any processing that results in a representation of the concepts in space. For example, in one possible embodiment, the spatial processing may include the display of the information associated with the concept vectors (e.g. in Euclidean space, etc.).

To this end, in some optional embodiments, one or more of the foregoing features may enable generation of vectors related to concepts for use in spatial processing (e.g. displaying in Euclidian space) without necessarily relying on deep learning algorithms. This may, in turn, result in the production of such concept vectors (that are equipped for spatial domain processing) in a faster, more cost-effective manner that would otherwise be foregone in systems that lack such capabilities. It should be noted that the aforementioned potential advantages are set forth for illustrative purposes only and should not be construed as limiting in any manner.

More illustrative information will now be set forth regarding various optional architectures and uses in which the foregoing method 100 may or may not be implemented, per the desires of the user. For example, in various embodiments, the method 100 may be carried out for a variety of different purposes. It should be noted that the following information is set forth for illustrative purposes and should not be construed as limiting in any manner. Any of the following features may be optionally incorporated with or without the exclusion of other features described.

For example, in one embodiment, the spatial processing may include deep learning. Such deep learning may include a set of algorithms that model high-level abstractions in data using a deep graph with multiple processing layers, composed of multiple linear and non-linear transformations. Such deep learning may thus be applied to the concept vectors for further enhancing insight into relationships among the underlying concepts.

In another embodiment, the spatial processing may include text analysis. As mentioned earlier, the concepts may include one or more words. In such embodiment, various text analysis may be applied to the concept vectors to gain further insight into relationships among such words. Such text analysis may be in the form of a text characterization, text summarization, sentiment analysis, and/or any other analysis involving the text and/or underlying meaning of the text, for that matter.

In still yet another embodiment, the spatial processing may include clustering. As an example, such clustering may include the graphical representation of the concepts using the concept vectors. Specifically, the concept vectors may identify an area in space in which the corresponding concepts may be positioned, and additional algorithms may be applied to group (e.g. cluster, etc.) the concepts based on their relative proximity in space.

In still yet another embodiment, the concepts may include a phrase or a plurality of words of a sentence. In such embodiment, the concept vectors may be assembled into a concept matrix representative of the sentence. Specifically, each of the words of the sentence may have an associated concept vector that may, in turn, constitute, one of a plurality rows of the aforementioned concept matrix. By this design, the concept matrix may enable any desired analysis (see the examples above) of the sentence, as a whole, either by itself or relative to other concept matrices of other sentences.

While various exemplary applications have been set forth, it should be noted that they are illustrative in nature and should not be construed as limiting in any manner. A very specific, optional example of an implementation of the method 100 of FIG. 1 will now be set forth. Specifically, the current example is set forth in the context of concepts that each correspond with a word and have associated relationship information that details a relationship (e.g. distance between) the different words, based on their relative meaning.

Specifically, based on a lexical semantic knowledgebase, e.g. WORDNET, dissimilarities between concepts can be measured. In such embodiment, the concept vectors may be constructed in a Euclidean space, using multidimensional scaling (MDS), where a distance reveals any dissimilarity among the words, and the inner product reveals a geometry of any semantics.

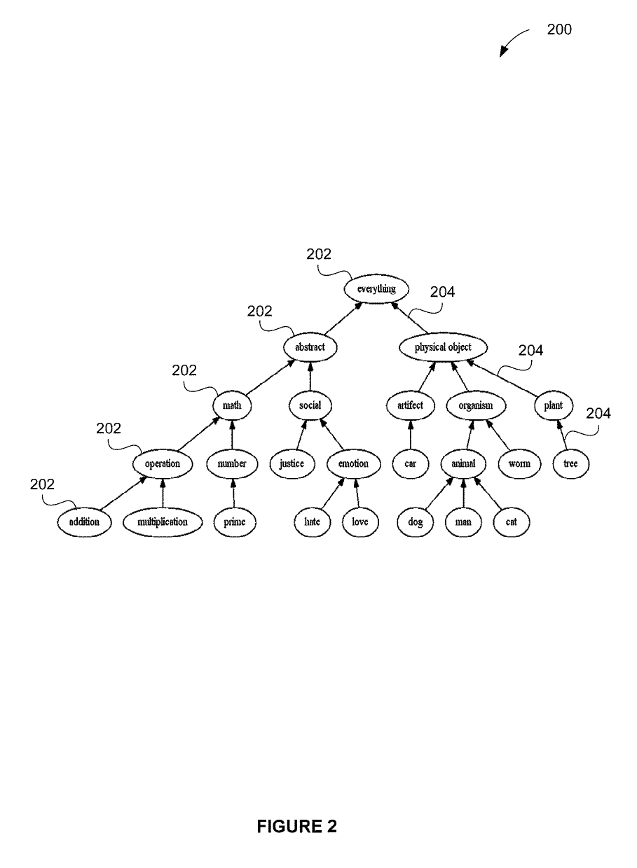

FIG. 2 illustrates an exemplary knowledgebase 200 including a plurality of concepts 202 (e.g. with associated words, etc.) and relationships 204 therebetween, in accordance with an embodiment. In use, a distance matrix may be generated by and received from the knowledgebase 200 (e.g. per step 102 of FIG. 1), or can be obtained in any manner. As shown, the relationships 204 between any two concepts 202 may be measured, for instance, by measuring a length of a shortest path therebetween. For example, the “math” and “addition” concepts are separated by a distance of two in the figure.

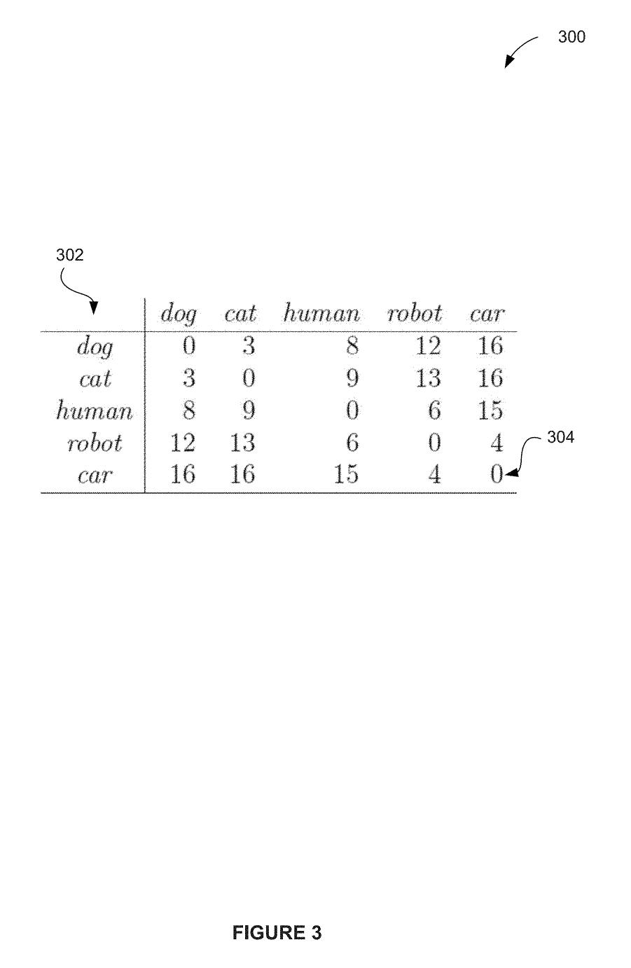

FIG. 3 illustrates an exemplary distance matrix 300 including a plurality of concepts 302 and relative distance values 304, in accordance with an embodiment. It should be noted that the particular distance values 304 are arbitrary and thus set forth for illustrative purposes, and do not necessarily correlate specifically with the knowledgebase 200 of FIG. 2. In use, an inner product matrix may be derived from the distance matrix 300 of the knowledgebase (e.g. per step 104 of FIG. 1).

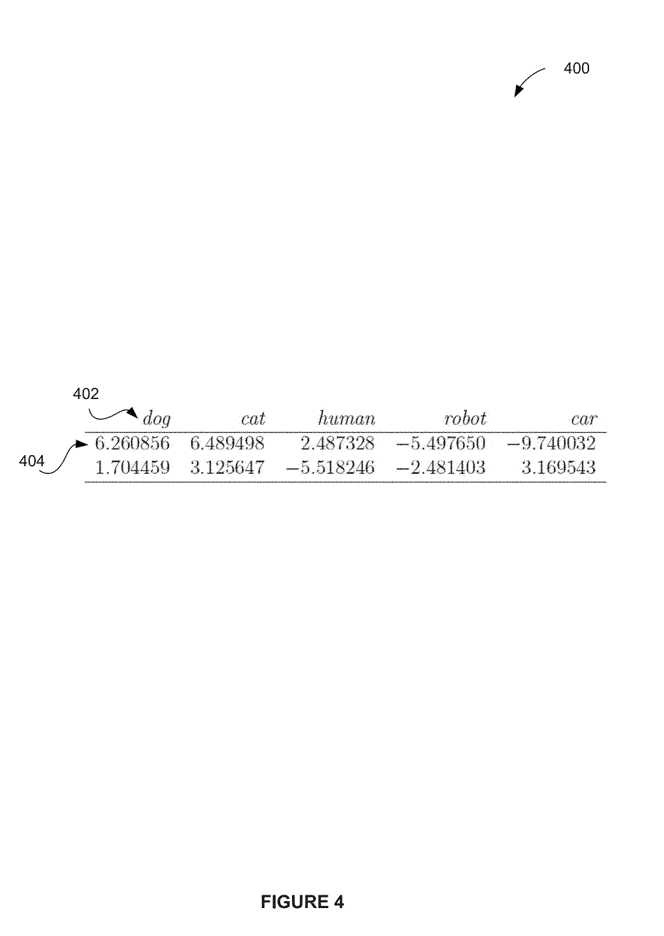

FIG. 4 illustrates an exemplary inner product matrix 400 including a plurality of concepts 402 and inner product values 404, in accordance with an embodiment. Specifically, given k =2, and by the method 100 of FIG. 1, two-dimensional concept vectors are provided in columns, in the manner shown. By this design, a spectral decomposition may be performed to generate concept vectors that may, in turn, be used for spatial processing (e.g. see operations 106-110 of FIG. 1).

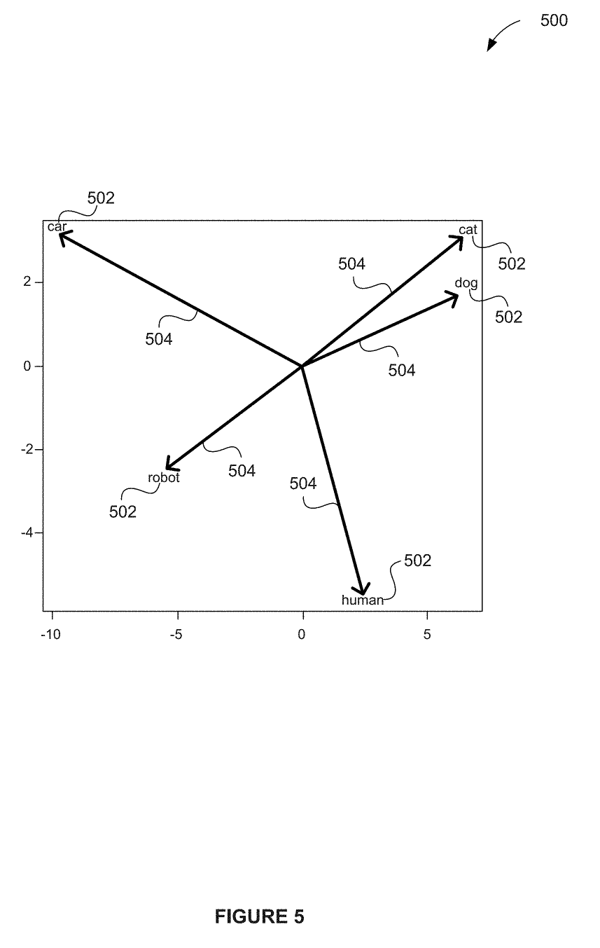

FIG. 5 is a plot 500 resulting from spatial processing of concepts 502, in accordance with an embodiment. As shown, a distance 504 between each of the concepts 502 is illustrated graphically in Euclidean space. In the figure, the horizontal and vertical axes represent node positions in two-dimensional space, with units of both axes comprising distances from the origin (where the origin is at 0,0 in the graph, at the conjunction of the concepts 502). By this design, greater insight is provided into the underlying concepts 502 and their relationship.

The present techniques thus provide an approach to represent concepts by way of geometry. Any semantics are thus formalized and can be further applied to the practice of natural language processing, for instance, word sense disambiguation, semantic analysis, text summarization, etc. Further, the techniques disclosed herein may be used as a general method to geometrize the sequential data. For instance, by concept vectors, any sentence can be transformed to an image (e.g. matrix). Therefore, image processing techniques may be further applied to natural language processing problems.

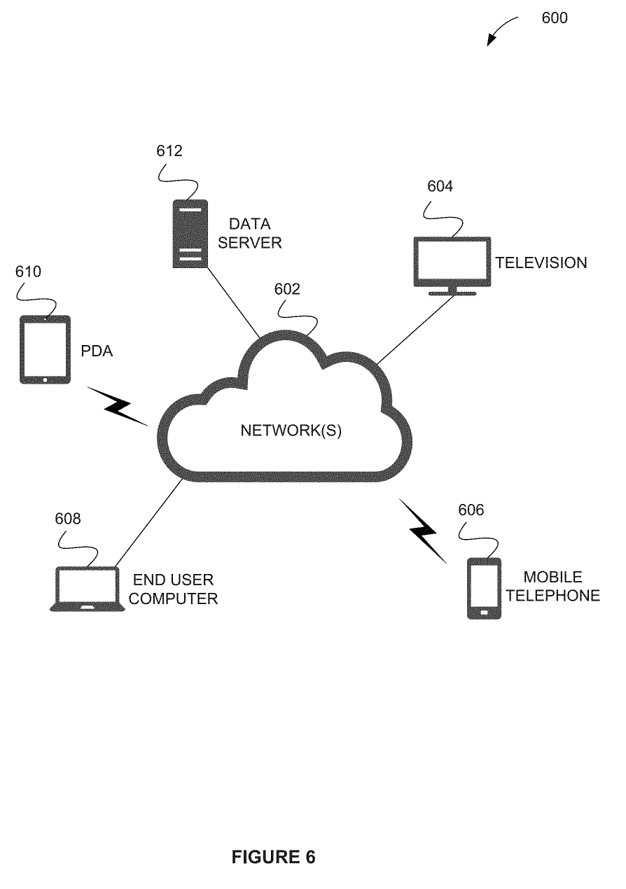

FIG. 6 illustrates a network architecture 600, in accordance with an embodiment. As shown, at least one network 602 is provided. In various embodiments, any one or more components/features set forth during the description of any previous figure(s) may be implemented in connection with any one or more of the components of the at least one network 602.

In the context of the present network architecture 600, the network 602 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 602 may be provided.

Coupled to the network 602 is a plurality of devices. For example, a data server computer 612 and an end user computer 608 may be coupled to the network 602 for communication purposes. Such end user computer 608 may include a desktop computer, lap-top computer, and/or any other type of logic. Still yet, various other devices may be coupled to the network 602 including a personal digital assistant (PDA) device 610, a mobile phone device 606, a television 604, etc.

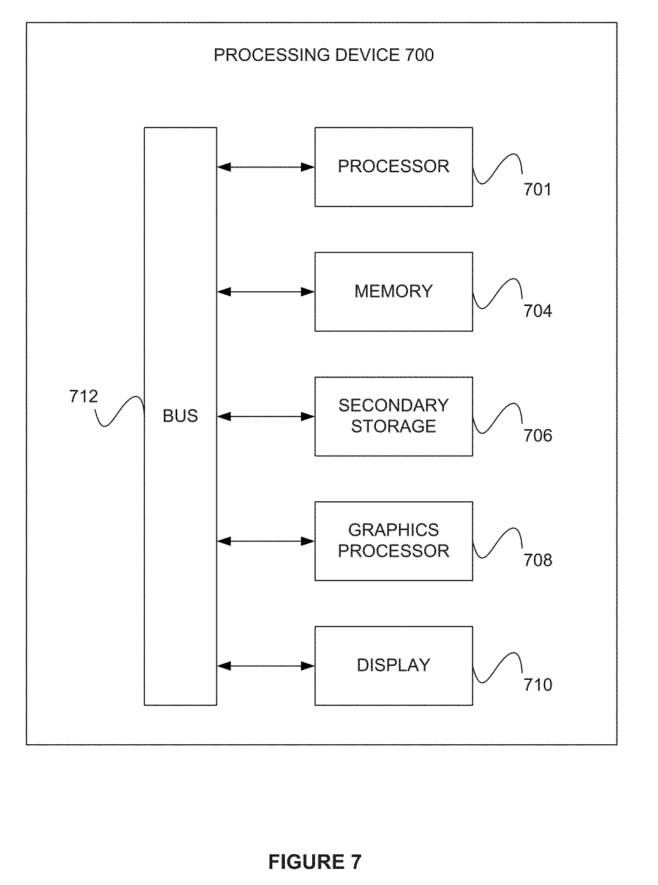

FIG. 7 illustrates an exemplary processing device 700, in accordance with an embodiment. As an option, the processing device 700 may be implemented in the context of any of the devices of the network architecture 600 of FIG. 6. However, it is to be appreciated that the processing device 700 may be implemented in any desired environment.

As shown, a processing device 700 is provided including at least one processor 701 which is connected to a bus 712. In one embodiment, the at least one processor 701 or any other processor, for that matter, may be used to process data (e.g. see steps 104-410 of FIG. 1, etc). The processing device 700 also includes memory 704 [e.g., hard disk drive, solid state drive, random access memory (RAM), etc.] coupled to the bus 712.

The processing device 700 may include a graphics processor 708 and an input/output (I/O) interface 710 coupled to the bus 712. Such I/O interface 710 may, in one embodiment, include one or more input devices (e.g. local/remote network interface, memory access interface, user input device such as a keyboard/mouse, etc.) for receiving data (e.g. see step 102 of FIG. 1, etc.). Further, such I/O interface 710 may, in another embodiment, include one or more output devices (e.g. display, printer, touchscreen, etc.) for displaying data (e.g. see step 110 of FIG. 1, etc.).

The processing device 700 may also include a secondary storage 706 coupled to the bus 712 and/or to other components of the processing device 700. The secondary storage 706 can include, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the memory 704, the secondary storage 706, and/or any other memory, for that matter. Such computer programs, when executed, enable the processing device 700 to perform various functions (as set forth above, for example). Memory 704, secondary storage 706 and/or any other storage comprise non-transitory computer-readable media.

In one embodiment, the at least one processor 701 executes instructions in the memory 704 or in the secondary storage 706 to derive an inner product matrix based on a distance matrix, with the distance matrix including values representing dissimilarities among a plurality of concepts stored in a knowledgebase, derive an inner product matrix based on the distance matrix, perform a spectral decomposition of the inner product matrix, generate a plurality of concept vectors based on the spectral decomposition of the inner product matrix, and output information associated with the plurality of concept vectors for spatial processing.

In some embodiments, the spectral decomposition of the inner product matrix is configured such that the plurality of concept vectors are generated with a dimension that is equal to a rank of the inner product matrix. In some embodiments, the spectral decomposition of the inner product matrix is configured such that the plurality of concept vectors are generated with a dimension that is less than a rank of the inner product matrix.

In some embodiments, a user input is received including a dimension, wherein the plurality of concept vectors are generated with the dimension based on the spectral decomposition of the inner product matrix.

In some embodiments, the spatial processing includes displaying the information associated with the plurality of concept vectors. In some embodiments, the spatial processing includes displaying the information associated with the plurality of concept vectors in Euclidean space.

In some embodiments, a concept of the plurality of concepts includes at least one word, a phrase, or a plurality of words of a sentence.

In some embodiments, the plurality of concept vectors are assembled into a concept matrix representative of the sentence.

In some embodiments, the spatial processing includes at least one of deep learning, text analysis, or clustering.

In some embodiments, the information associated with the plurality of concept vectors includes one or both of the plurality of concept vectors or information derived from the plurality of concept vectors.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), or the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; or the like.

It should be understood that the arrangement of components illustrated in the Figures described are exemplary and that other arrangements are possible. It should also be understood that the various system components defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A processing device, comprising:
a non-transitory memory comprising a distance matrix and instructions, with the distance matrix including values representing dissimilarities among a plurality of concepts stored in a knowledgebase;
one or more processors in communication with the memory, wherein the one or more processors execute the instructions to:
derive an inner product matrix based on the distance matrix;
perform a spectral decomposition of the inner product matrix;
generate a plurality of concept vectors based on the spectral decomposition of the inner product matrix; and
output information associated with the plurality of concept vectors for spatial processing.

2. The processing device of claim 1, wherein the spectral decomposition of the inner product matrix is configured such that the plurality of concept vectors are generated with a dimension that is equal to a rank of the inner product matrix.

3. The processing device of claim 1, wherein the spectral decomposition of the inner product matrix is configured such that the plurality of concept vectors are generated with a dimension that is less than a rank of the inner product matrix.

4. The processing device of claim 1, wherein the one or more processors further execute the instructions to:
receive user input including a dimension, wherein the plurality of concept vectors are generated with the dimension based on the spectral decomposition of the inner product matrix.

5. The processing device of claim 1, wherein the spatial processing includes displaying the information associated with the plurality of concept vectors.

6. The processing device of claim 1, wherein the spatial processing includes displaying the information associated with the plurality of concept vectors in Euclidean space.

7. The processing device of claim 1, wherein a concept of the plurality of concepts includes at least one word, a phrase, or a plurality of words of a sentence.

8. The processing device of claim 7, wherein the one or more processors further execute the instructions to assemble the plurality of concept vectors into a concept matrix representative of the sentence.

9. The processing device of claim I, wherein the spatial processing includes at least one of deep learning, text analysis, or clustering.

10. The processing device of claim 1, wherein the information associated with the plurality of concept vectors includes one or both of the plurality of concept vectors or information derived from the plurality of concept vectors.

11. A method, comprising:
a processing device deriving an inner product matrix based on a distance matrix, with the distance matrix including values representing dissimilarities among a plurality of concepts stored in a knowledgebase;
the processing device performing a spectral decomposition of the inner product matrix;
the processing device generating a plurality of concept vectors based on the spectral decomposition of the inner product matrix; and
the processing device outputting information associated with the plurality of concept vectors for spatial processing.

12. The method of claim 13, further comprising the processing device receiving user input including a dimension, wherein the plurality of concept vectors are generated with the dimension based on the spectral decomposition of the inner product matrix.

13. The method of claim 13, wherein the spectral decomposition of the inner product matrix is configured such that the plurality of concept vectors are generated with a dimension that is equal to a rank of the inner product matrix.

14. The method of claim 13, wherein the spectral decomposition of the inner product matrix is configured such that the plurality of concept vectors are generated with a dimension that is less than a rank of the inner product matrix.

15. The method of claim 13, wherein the spatial processing includes displaying the information associated with the plurality of concept vectors.

16. The method of claim 13, wherein the spatial processing includes displaying the information associated with the plurality of concept vectors in Euclidean space.

17. The method of claim 13, wherein a concept of the plurality of concepts includes at least one word, a phrase, or a plurality of words of a sentence.

18. The method of claim 17, further comprising assembling the plurality of concept vectors into a concept matrix representative of the sentence.

19. The method of claim 13, wherein the spatial processing includes at least one of deep learning, text analysis, or clustering.

20. The method of claim 13, wherein the information associated with the plurality of concept vectors includes one or both of the plurality of concept vectors or information derived from the plurality of concept vectors.

21. A non-transitory computer-readable media storing computer instructions, that when executed by one or more processors, cause the one or more processors to perform the steps of:
deriving an inner product matrix based on a distance matrix, with the distance matrix including values representing dissimilarities among a plurality of concepts stored in a knowledgebase;
performing a spectral decomposition of the inner product matrix;
generating a plurality of concept vectors based on the spectral decomposition of the inner product matrix; and
outputting information associated with the plurality of concept vectors for spatial processing.
